(19) United States
(12) Patent Application Publication
(10) Pub. No.: US 2003/0041022 A1
(43) Pub. Date: Feb. 27, 2003

(54) Electronic money instrument

(76) Inventors: Tatia L. Battle, Jackson, MS (US); James D. Blocker, Jackson, MS (US); Lila Cooper, Jackson, MS (US)

Correspondence Address: Michael I. Kroll, 171 Stillwell Lane, Syosset, NY, 11791, US

(21) Appl. No.: 09/933,796

(22) Filed: Aug. 21, 2001

(51) Int. Cl. G06F 17/60

(52) U.S. Cl. 705/39

(57) ABSTRACT

Methods and related computer system hardware and software are provided for an electronic money instrument, delivered by an issuer to a consumer in a specific amount having a unique serial number. The consumer, who does not wish to disclose credit card, debit card or other account information in an online transaction, determines the total amount needed from a first visit to a vendor's online website, and then purchases the electronic money instrument, in the same amount, from the issuer at a retail outlet. In a second visit to the website, the consumer uses the electronic money instrument for payment by inputting the unique serial number on the electronic money instrument. The website vendor then submits a funds transfer request to the issuer for approval. If approved the online transaction is then consummated and the issuer places a halt on any further use of the serial number.

### FIELD OF THE INVENTION

The present invention relates generally to non-cash methods of paying for consumer transactions.

### DESCRIPTION OF THE PRIOR ART

There are other prepaid transaction instruments designed for prepayment of goods and services. Typical of these is U.S. Pat. No. 5,477,038 issued to Levine, et al. on Dec. 19, 1995.

Another patent was issued to Muehlberger, et al. on Dec. 9, 1997 as U.S. Pat. No. 5,696,908. Yet another U.S. Pat. No. 5,749,075 was issued to Toader, et al. on May 5, 1998 and still yet another was issued on Oct. 20, 1998 to Wise, et al. as U.S. Pat. No. 5,826,185.

Another patent was issued to Toader on Sep. 8, 1998 as U.S. Pat. No. 5,806,043. Yet another U.S. Pat. No. Re. 36,365 was issued to Levine, et al. on Nov. 2, 1999.

### U.S. Pat. No. 5,477,038

### Inventor: Jack Levine et al.

### Issued: Dec. 19, 1995

A process which provides electronic access to pre-paid funds for cash or payment for goods and services. A card is issued to a customer with a value selectable by the customer. The card has a magnetic stripe with an encoded card number including a bank identification number (BIN) and an account number. The central card processor establishes a zero balance database including the card numbers, but with blank fields for the customer data and the value of the account. When a customer purchases a card, the sales agent transmits to the central database computer which fills in the blanks in the database, activating the account, and transmits an acknowledgment signal back to the sales agent. The customer can immediately use the card in ATM or other remote terminals to acquire cash or purchase goods and services. The customer inputs a PIN number which is provided with the card, or a customer selected alternative PIN number.

### U.S. Pat. No. 5,696,908

### Inventor: Muehlberger et al.

### Issued: Dec. 9, 1997

Telephone debit cards are automatically vended through a microprocessor controlled vending machine which permits card payment in cash and credit. The customer can select a desired telephone card value and a desired telecommunications carrier. Prepaid and printed cards are dispensed. Optionally, printed receipts are dispensed including an access code and prepaid value. The vending machine generates real-time communications with an electronics funds clearing house for customer validity and funds approval. After electronics transfer of funds to the machine, the telephone debit card is dispensed and funds are electronically transferred to the selected telecommunications carrier via real-time communications with the carrier for electronic transfer of the card value thus permitting immediate use of the telephone card by the customer.

### U.S. Pat. No. 5,749,075

### Inventor: Adrian Toader et al.

### Issued: May 5, 1998

A method for providing prepaid Internet Access and/or long distance including the distribution of specialized calling cards, each with a unique PIN number associated therewith. Each card entitles a recipient to limited access to the Internet, free or low cost Internet access software, and/or time limited long distance calls. The cards can be a sponsor promotion in which the card holder is automatically hot-linked into the sponsor's Internet home page where he or she is given a “guided tour”. An “Enhanced Entry Server” (EES), verifies the PIN number, provides the Internet and/or long distance access and times the sponsor paid Internet access or calling time.

### U.S. Pat. No. 5,826,185

### Inventor: Andrew Wise

### Issued: Oct. 20, 1998

A cellular phone system in which a cellular phone user (CPU) has a cellular phone with a predetermined amount of available airtime. The CPU prepays for a particular number of airtime units. When a cell site receives a call from the CPU, the cell site communicates with a mobile telecommunications switching office (MTSO), which recognizes a unique serial number from the cellular phone. The MTSO directs the call to a prepaid airtime transaction tracking interface (PATTI). The PATTI then checks whether the CPU's account has any available airtime units and may indicate the number of units to the CPU. If none, the PATTI does not answer the call; otherwise, the PATTI connects the call and deducts airtime units until the call is disconnected.

### U.S. Pat. No. 5,806,043

### Inventor: Adrian Toader

### Issued: Sep. 8, 1998

A method for a sponsor/vendor to provide customer online help support for consumer products such as software includes providing a prepaid Internet access account which is supplied with the consumer product. Upon accessing the Internet the customer is “hot-linked” to the domain of the sponsor/vendor where help queries can be input and help answers received, either in real time or in a time delayed fashion via E-mail. The sponsor/vendor can mandate a tour of the domain for marketing purposes prior to allowing access to on-line help services. Finally, registration of the customer is promoted since registration can be made an integral part of the log on procedure.

### U.S. Pat. No. Re. 36,365

### Inventor: Jack Levine et al.

### Issued: Nov. 2, 1999

A process which provides electronic access to pre-paid funds for cash or payment for goods and services. A card is issued to a customer with a value selectable by the customer. The card has a magnetic stripe with an encoded card number including a bank identification number (BIN) and an account number. The central card processor establishes a zero balance database including the card numbers, but with blank fields for the customer data and the value of the account. When a customer purchases a card, the sales agent transmits to the central database computer which fills in the blanks in the database, activating the account, and transmits an acknowledgment signal back to the sales agent. The customer can immediately use the card in ATM or other remote terminals to acquire cash or purchase goods and services. The customer inputs a PIN number which is provided with the card, or a customer selected alternative PIN number.

The typical consumer is uncomfortable in providing credit card account numbers, debit card account numbers, and the like, while online. Any time a credit card, or other non-cash account identification number is usable more than once, the first communication of the number to a vendor, even in person, puts the consumer at risk of a second unauthorized use. What is needed is a non-cash payment method that eliminates the second use, while retaining the convenience of a non-cash payment, especially online payments.

### SUMMARY OF THE PRESENT INVENTION

A primary object of the present invention is to provide an alternate payment method for Internet electronic commerce sites.

Another object of the present invention is to reduce the need to input sensitive consumer financial information such as, credit and/or debit card numbers to complete electronic commerce purchases.

Yet another object of the present invention is to help reduce the consumers impulse buying.

Still yet another object of the present invention is to reduce the consumers exposure to credit card fraud by eliminating the repetitious logging of sensitive consumer financial information by vendors.

Yet another object of the present invention is to provide retail outlets wherein consumers can purchase electronic money instruments for a value specified by the consumer at time of purchase.

Still yet another object of the present invention is to provide a financial instrument having a serial number that will be used only once.

Additional objects of the present invention will appear as the description proceeds.

This invention involves a prepaid electronic money instrument, having a unique serial number and a value specified by the consumer at time of purchase. The serial number is usable only once, with the related issuer accounting and verification system preventing a second use.

The electronic money instrument is purchased by the consumer at a participating outlet that issues the instrument. The electronic money instrument can be used as a payment method for vendor's goods and services, as well as, contributions to charities, loan payments, and the like. The outlet, which can be a retail outlet, issues the electronic money instrument to the consumer upon the consumer's payment by any acceptable financial means, such as check, cash, credit card, debit card, etc. The consumer specifies the value of the electronic money instrument at the time of purchase.

The electronic money instrument has a serial number and is basically a bearer instrument. Upon issue the electronic money instrument will be recorded into an account database of electronic money instruments maintained by the issuing outlet. The recording of the electronic money instrument will consist of at least an amount and electronic money instrument serial number. The consumer later provides the electronic money instrument serial number to the vendor of their choice as a means of payment.

To complete an online purchase from a vendor, the consumer visits the vendor's online site, makes the desired selections, and then records the amount necessary to complete the transaction. The consumer then acquires the electronic money instrument from an issuing outlet that is equal in value to the amount needed.

The consumer returns to the vendor's site and inputs the electronic money instrument serial number as the method of payment. The vendor initiates an electronic funds transfer request with the electronic money issuer, using the unique serial number and the amount due. Upon the issuer's internal verification that the serial number has not been previously used, and that the amount is correct, the issuer approves the vendor's funds transfer request, leading to the approval of the consumer's purchase. This process eliminates the disclosure and/or recording of sensitive consumer information by vendors, such as a credit card number, or bank account number, and will to some degree reduce the consumer's impulse buying.

In one embodiment, a method is provided for providing tender from an issuer for a user transaction with a third party, the method comprising the steps of: receiving a request from the user for the tender in a specified amount; issuing to the user an item having a unique serial number to the user; retrievably storing item information associating the tender amount with the serial number; receiving a request for funds from the third party, the request including the serial number and the amount requested; accessing the stored item information to determine if the tender amount associated with the serial number is at least as large as the requested amount; approving the request if the tender amount associated with the serial number is at least as large as the requested amount; refusing the request if the tender amount associated with the serial number is less than the requested amount; and upon approval, retrievably storing additional item information associating the serial number with an indication that no further third party requests for funds can be approved.

In another embodiment of the method, the step of retrievably storing item information includes storage in a remote hosting site serving more than one issuer.

In another embodiment of the method, the user determines the amount of tender required to consummate the transaction with the third party prior to requesting the tender from the issuer

In another embodiment of the method, this determination is made using the information available on the third party's online site.

In another embodiment of the method, the third party's request to the issuer is made by electronic communication

In another embodiment of the method, the third party's request to the issuer is made online

In another embodiment of the method, the method further comprises the step, by the issuer, of reimbursing the user for the difference between the tender amount and the amount of the approved third party request for funds.

In another embodiment of the method, the reimbursement is made upon presentation of the item to the issuer.

In another embodiment of the method, the presentation of the serial number to the issuer is made online.

In another embodiment of the method, the step of receiving a request for a tender from a user further comprises: receiving the request at a site that is remote from the issuer; and forwarding the request from the remote site for receipt by the issuer.

In another embodiment of the method, the site is a retail outlet selling the tender item.

In another embodiment of the method, the step of issuing to the user an item having a unique serial number further comprises issuing the item for receipt by the user at the remote site.

In another embodiment of the method, the item is a printed instrument.

In another embodiment of the method, the item is an email to a location specified by the user.

In another embodiment of the method, the item is an online message to a location specified by the user.

In another embodiment of the method, the method further comprises the step of receiving a consideration from the user for issuing the item.

In another embodiment of the method, the method further comprises the step of receiving a consideration from the third party for presenting the item for payment.

In another embodiment of the method, the issued item also includes issuer contact information.

In another embodiment of the method, the third party is the vendor.

In another embodiment of the method, the third party is selling goods in the transaction.

In another embodiment of the method, the third party is selling services in the transaction.

In another embodiment of the method, the third party is accepting contributions in the transaction.

In another embodiment of the method, the third party is accepting payments for previously owed sums in the transaction.

In another embodiment of the method, the method further comprises a method for the third party to allow the user to use the issued tender item as tender for an online transaction with the third party, the method comprising the steps, by the third party, of: providing a user-accessible online transaction site; receiving the user's inputted selection of subject matter to be included in the transaction; determining the amount of tender required to consummate the transaction based on the user's inputted selection of subject matter, and communicating the amount to the user; receiving the user's selection of the issued tender item as the type of tender to be used to consummate the transaction; receiving the tender item identification information upon entry by the user; choosing between acceptance or rejection of the tender item, and communicating the choice to the user.

In another embodiment of the method, the subject matter includes goods.

In another embodiment of the method, the subject matter includes services.

In another embodiment of the method, the subject matter includes donations to the third party.

In another embodiment of the method, the subject matter includes payment of sums previously owed to the third party.

In one embodiment, a method is provided for providing tender from an issuer for a user transaction with a third party, the method comprising the steps of: receiving a request from the user for the tender in a specified amount; issuing an item having a unique serial number to the user; retrievably storing item information associating the tender amount with the serial number; receiving a request for funds from the third party, the request including the serial number and the amount requested; accessing the stored item information to determine if the tender amount associated with the serial number is equal to the requested amount; approving the request if the tender amount associated with the serial number is equal to the requested amount; refusing the request if the tender amount associated with the serial number is not equal to the requested amount; and if the third party request for funds was approved, retrievably storing additional item information associating the serial number with an indication that no further third party requests for funds can be honored.

In one embodiment, a method is provided for providing online transactions between a vendor and a user, the method comprising the steps, by the user, of: accessing the vendor's online site; selecting at least one item for purchase; proceeding to checkout; selecting between payment by an electronic money instrument and other payment methods; if other payment methods are chosen, making payment with non-electronic money instrument; if the electronic money instrument payment method is chosen, determining if an electronic money instrument is available in the amount required for payment; if not available, noting the amount required, selecting an issuing outlet, purchasing the electronic money instrument from the outlet in the amount required, returning to the online site, and entering the electronic money instrument serial number as the payment method; if available, entering the electronic money instrument serial number as the payment method; upon entry of the serial number, waiting for the vendor to authenticate the electronic money instrument, by contacting the issuer, providing the serial number, requesting finds transfer, and receiving issuer approval; and receiving an online approval from the vendor if the issuer verification was successful; receiving an online rejection if the issuer verification was unsuccessful.

In one embodiment, a system is provided for providing tender from an issuer for a user transaction with a third party, the system comprising: means for receiving a request from the user for the tender in a specified amount; means for issuing to the user an item having a unique serial number to the user; means for retrievably storing item information associating the tender amount with the serial number; means for receiving a request for funds from the third party, the request including the serial number and the amount requested; means for accessing the stored item information to determine if the tender amount associated with the serial number is at least as large as the requested amount; means for approving the request if the tender amount associated with the serial number is at least as large as the requested amount; means for refusing the request if the tender amount associated with the serial number is less than the requested amount; and means for retrievably storing additional item information associating the serial number with an indication that no further third party requests for funds can be approved after the first approval.

In another embodiment of the system, the means for retrievably storing item information includes means for storage in a remote hosting site serving more than one issuer.

In another embodiment of the system, the system further comprises means for determining the amount of tender required to consummate the transaction with the third party, prior to requesting the tender from the issuer.

In another embodiment of the system, said means comprises the third party's online site.

In another embodiment of the system, the means for receiving the third party's request for funds comprises electronic communication equipment.

In another embodiment of the system, the means for receiving the third party's request for funds comprises online communication equipment.

In another embodiment of the system, the system further comprises means for the issuer to reimburse the user for the difference between the tender amount and the amount of the approved third party request for funds.

In another embodiment of the system, the means for receiving a request for a tender from the user further comprises: means for receiving the request at a site that is remote from the issuer; and means for forwarding the request from the remote site for receipt by the issuer.

In another embodiment of the system, the site is a retail outlet selling the tender item.

In another embodiment of the system, the means for issuing to the user an item having a unique serial number to the user further comprises means for issuing the item for receipt by the user at the remote site.

In another embodiment of the system, the item is a printed instrument.

In another embodiment of the system, the item is an email to a location specified by the user.

In another embodiment of the system, the item is an online message to a location specified by the user.

In another embodiment of the system, the system further comprises a system for the third party to allow the user to use the issued tender item as tender for an online transaction with the third party, the system comprising: means for providing a user-accessible online transaction site; means for receiving the user's inputted selection of subject matter to be included in the transaction; means for determining the amount of tender required to consummate the transaction based on the user's inputted selection of subject matter, and means for communicating the amount to the user; means for receiving the user's selection of the issued tender item as the type of tender to be used to consummate the transaction; means for receiving the tender item identification information upon entry by the user; means for choosing between acceptance or rejection of the tender item, and means for communicating the choice to the user.

In one embodiment, a system is provided for providing tender from an issuer for a user transaction with a third party, the system comprising: means for receiving a request from the user for the tender in a specified amount; means for issuing an item having a unique serial number to the user; means for retrievably storing item information associating the tender amount with the serial number; means for receiving a request for funds from the third party, the request including the serial number and the amount requested; means for accessing the stored item information to determine if the tender amount associated with the serial number is equal to the requested amount; means for approving the request if the tender amount associated with the serial number is equal to the requested amount; means for refusing the request if the tender amount associated with the serial number is not equal to the requested amount; and means for retrievably storing additional item information associating the serial number with an indication that no further third party requests for funds can be honored after the first approval.

In one embodiment, a system is provided for providing online transactions between a vendor and a user, the system comprising: means for accessing the vendor's online site; means for selecting at least one item for purchase; means for proceeding to checkout; means for selecting between payment by an electronic money instrument and other payment methods; means for if other payment methods are chosen, means for making payment with non-electronic money instrument, if other payment methods are chosen; if the electronic money instrument payment method is chosen, means for determining if an electronic money instrument is available in the amount required for payment if the electronic money instrument payment method is chosen; means for noting the amount required, selecting an issuing outlet, purchasing the electronic money instrument from the outlet in the amount required, returning to the online site, and entering the electronic money instrument serial number as the payment method, if the electronic money instrument is not available; means for entering the electronic money instrument serial number as the payment method, if the electronic money instrument is available; means for the vendor to authenticate the electronic money instrument, by contacting the issuer, providing the serial number, requesting funds transfer, and receiving issuer approval; and means for receiving an online approval from the vendor if the issuer verification was successful, or an online rejection if the issuer verification was unsuccessful.

In one embodiment, a system is provided for providing tender from an issuer for a user transaction with a third party, the system comprising: a storage device; a processor programmed to: receive a request from the user for the tender in a specified amount; issue to the user a tender item having a unique serial number to the user; retrievably store item information associating the tender amount with the serial number; receive a request for funds from the third party, the request including the serial number and the amount requested; access the stored item information to determine if the tender amount associated with the serial number is at least as large as the requested amount; communicate approval of the request to the third party if the tender amount associated with the serial number is at least as large as the requested amount; communicate refusal of the request to the third party if the tender amount associated with the serial number is less than the requested amount; and upon approval, retrievably store additional item information associating the serial number with an indication that no further third party requests for funds can be approved.

In another embodiment of the system, the system further comprises a printer, such that the tender item is issuable by printing.

In another embodiment of the system, the system further comprises a communication device, such that the processor issues the tender item by electronic communication with a site accessible by the user.

In another embodiment of the system, the processor is further programmed to record a balance owed to the user if the amount requested by the vendor is less than the tender amount associated with the serial number.

In another embodiment of the system, the storage device is a remote hosting site.

In another embodiment of the system, the third party's request to the issuer is made online.

In another embodiment of the system, the system further comprises at least one additional processor programmed to: receive the user's inputted selection of subject matter to be included in the transaction from an online transaction site; determine the amount of tender required to consummate the transaction based on the user's inputted selection of subject matter, and communicate the amount to the user through the online transaction site; receive from the online transaction site the user's selection of the issued tender item as the type of tender to be used to consummate the transaction; receive from the online transaction site the tender item identification information upon entry by the user; and choose between acceptance or rejection of the tender item, and communicate the choice to the user.

In one embodiment, a system is provided for providing tender from an issuer for a user transaction with a third party, the system comprising: a storage device; a processor programmed to: receive a request from the user for the tender in a specified amount; issue to the user a tender item having a unique serial number to the user; retrievably store item information associating the tender amount with the serial number; receive a request for funds from the third party, the request including the serial number and the amount requested; access the stored item information to determine if the tender amount associated with the serial number is equal to the requested amount; communicate approval of the request to the third party if the tender amount associated with the serial number is equal to the requested amount; communicate refusal of the request to the third party if the tender amount associated with the serial number is not equal to the requested amount; and upon approval, retrievably store additional item information associating the serial number with an indication that no further third party requests for funds can be approved.

In one embodiment, is provided computer readable media containing program instructions for execution on at least one computer system, which when executed by at least one computer, cause the at least one computer system to perform method steps for providing tender from an issuer for a user transaction with a third party, the method comprising the steps of: receiving a request from the user for the tender in a specified amount; issuing to the user an item having a unique serial number to the user; retrievably storing item information associating the tender amount with the serial number; receiving a request for funds from the third party, the request including the serial number and the amount requested; accessing the stored item information to determine if the tender amount associated with the serial number is at least as large as the requested amount; approving the request if the tender amount associated with the serial number is at least as large as the requested amount; refusing the request if the tender amount associated with the serial number is less than the requested amount; and upon approval, retrievably storing additional item information associating the serial number with an indication that no further third party requests for funds can be approved.

In another embodiment of the computer readable media the step of retrievably storing item information includes storage in a remote hosting site serving more than one issuer.

In another embodiment of the computer readable media, the method further comprises the step of recording a balance owed to the user if the amount requested by the vendor is less than the tender amount associated with the serial number.

In another embodiment of the computer readable media, the method further comprises the step, by the issuer, of reimbursing the user for the difference between the tender amount and the amount of the approved third party request for funds.

In another embodiment of the computer readable media, the third party's request to the issuer is made online

In another embodiment of the computer readable media, the media further contains program instructions for execution on at least one additional computer system, which when executed by the at least one additional computer system, causes the at least one computer system to perform method steps for the third party to allow the user to use the issued tender item as tender for an online transaction with the third party, the method comprising the steps of: providing a user-accessible online transaction site; receiving the user's inputted selection of subject matter to be included in the transaction; determining the amount of tender required to consummate the transaction based on the user's inputted selection of subject matter, and communicating the amount to the user; receiving the user's selection of the issued tender item as the type of tender to be used to consummate the transaction; receiving the tender item identification information upon entry by the user; and choosing between acceptance or rejection of the tender item, and communicating the choice to the user.

In one embodiment, computer readable media is provided containing program instructions for execution on at least one computer system, which when executed by at least one computer, cause the at least one computer system to perform method steps for providing tender from an issuer for a user transaction with a third party, the method comprising the steps of: receiving a request from the user for the tender in a specified amount; issuing to the user an item having a unique serial number to the user; retrievably storing item information associating the tender amount with the serial number; receiving a request for funds from the third party, the request including the serial number and the amount requested; accessing the stored item information to determine if the tender amount associated with the serial number is equal to the requested amount; approving the request if the tender amount associated with the serial number is equal to the requested amount; refusing the request if the tender amount associated with the serial number is not equal to the requested amount; and upon approval, retrievably storing additional item information associating the serial number with an indication that no further third party requests for funds can be approved.

The foregoing and other objects and advantages will appear from the description to follow. In the description reference is made to the accompanying drawings, which form a part hereof, and in which is shown by way of illustration specific embodiments in which the invention may be practiced. These embodiments will be described in sufficient detail to enable those skilled in the art to practice the invention, and it is to be understood that other embodiments may be utilized and that changes may be made without departing from the scope of the invention.

The following detailed description is, therefore, not to be taken in a limiting sense, and the scope of the present invention is best defined by the appended claims.

### BRIEF DESCRIPTION OF THE DRAWINGS

In order that the invention may be more fully understood, it will now be described, by way of example, with reference to the accompanying drawings in which:

FIG. 1 is an illustrative view of the present invention showing a payment method selection that would be provided by an online vendor. The electronic money instrument choice of payment method would provide the consumer with means for purchasing online products and services without disclosing their credit or debit card number and would still provide the vendor with immediate payment for good and services purchased online.

FIG. 2 and FIG. 3 combine to form a flow chart of the method employed by an online vendor providing an alternate method of payment for goods and services. The consumer selects an online vendor and items that they wish to purchase. After all items are selected the consumer proceeds to the site checkout and selects the method of payment. If the alternate method of payment is the electronic money instrument the consumer will be prompted for the serial number on the electronic money instrument. If the consumer does not have an electronic money instrument he or she must go to the nearest issuing outlet and purchase one for the total purchase price to complete the online transaction. When the consumer has purchased an electronic money instrument in the correct amount, he or she will enter the serial number. The vendor will establish communications with the host server for the electronic money data and verify the authenticity of the electronic money instrument and the amount. Upon successful verification of the serial number and amount the vendor will be notified as to the success or failure of the verification process and the consumer will be notified as to the approval of the transaction payment.

FIG. 4 is a block diagram indicating the consumer, issuer and vendor computer system functions and requirements.

### DETAILED DESCRIPTION OF THE PREFERRED EMBODIMENTS

The following discussion describes in detail one embodiment of the invention and several variations of that embodiment. This discussion should not be construed, however, as limiting the invention to those particular embodiments. Practitioners skilled in the art will recognize numerous other embodiments as well. For a definition of the complete scope of the invention, the reader is directed to the appended claims.

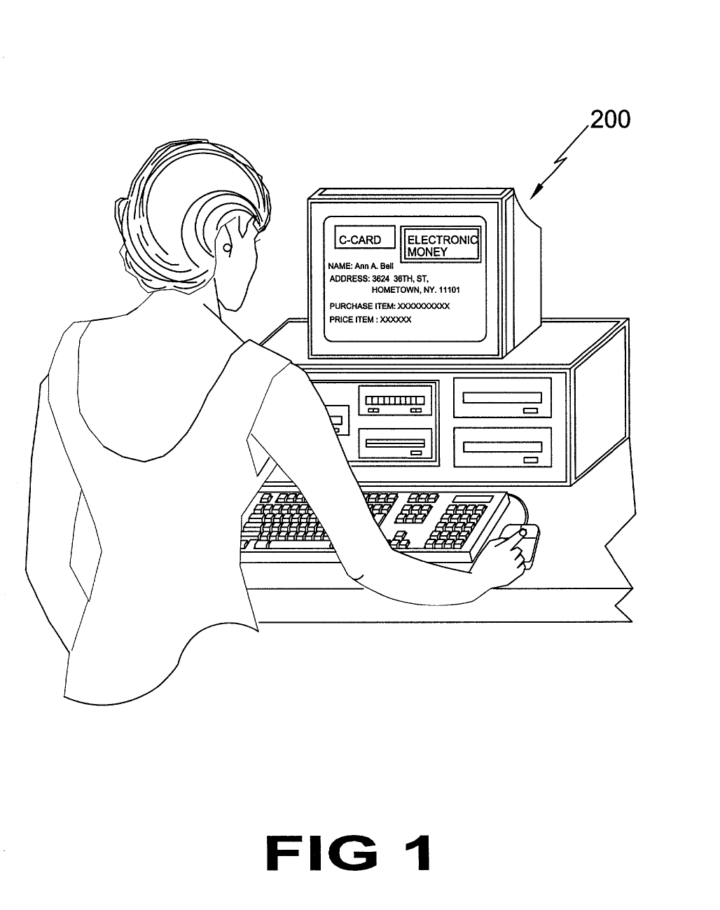

Turning now descriptively to the drawings, FIGS. 1-4 illustrate methods and systems involving the acquisition and use of the Electronic Money Instrument of the present invention.

As shown in FIG. 1, the invention is best implemented using computers and electronic communications. Electronic communications can include intranet components, and other specifically arranged communications that are not accessible by the general public, but the term especially includes “online” communications using the Internet in one or more of its developing forms, where organizations have established sites for the transactions involving the order and sale of goods and services, acceptance of contributions, making payments on bills and loans, transferring funds, and the like.

Although these electronic communications and the related computers and electronic processing equipment are the most efficient way to implement the invention, the unique benefits of the invention can be implemented manually in all or some aspects.

A person buying a product presents a tender that is something that is offered for payment. Currency is the most common example. This invention arranges for a special tender item to be issued to a user, typically a consumer, who has paid the proper amount of money to the issuer. That amount can be the exact amount of the tender, or such amount plus a fee for the issue service.

The tender item in the preferred embodiment is a physical instrument that includes a unique serial number and the tender amount. It is also referred to herein as the “electronic money instrument”. The issuer records the serial number and the tender amount. Electronic recording/storage of this information can be in an electronic database maintained at the site of issue, or can be accomplished by communication with a remote hosting site. The remote hosting site can be dedicated to the issuing site or can serve several sites.

The recording/storage is done in a manner such that a later search using the serial number will find the tender amount that is associated with such serial number. Following the original entry, the recorded information indicates that the serial number represents a tender item that is then ready to be used for a transaction.

The user possessing the tender item can present the tender in person or using electronic communications. For example, the user can present the tender item at a typical store, and the vendor would then seek verification that the tender item was valid for the amount needed to complete the transaction. The amount needed can be the exact cash price of the transaction, or it can include a special charge for the privilege of the using the tender item in lieu of other more typical forms of payment.

The third party vendor can present the tender item to the issuer, or the issuer's representative in any number of ways, including physical presentment. In the preferred embodiment, the vendor communicates electronically with the issuer and requests a funds transfer for the benefit of the vendor. This communication is done in such a manner that the unique serial number is searched in the issuer's database. This search confirms that a tender item bearing that serial number exists, and also confirms the tender amount associated with the serial number.

In one embodiment, the issuer's system approves the request for funds if the amount requested is equal to or less than the tender amount associated with the submitted serial number. If the amount requested is greater than such tender amount the request is rejected.

When the third party's request for funds is approved, the approval is communicated to the third party, who then completes the transaction with the user. Once an approval has been made an indication is entered into the issuer's system that prevents any further approvals with regard to the tender item. The tender item can only be used once, thus the fact that the serial number has been disclosed to the third party vendor can have no unintended consequences. Any future use of the serial number is automatically rejected.

If the amount requested by the third party is less than the tender item amount, the issuer's system determines the balance to be credited to the user. This can be reimbursed by check, or deposited in a user account, or other typical methods of reimbursing consumers for what is analogous to an overpayment. The balance is not available for a further request for transfer by a third party.

In another embodiment, the issuer's system will reject the request for funds unless the amount requested is an exact match with the tender amount associated with the serial number. An exact match will result in an approval. In such a system, it is unnecessary to record personal identification of the user in the database.

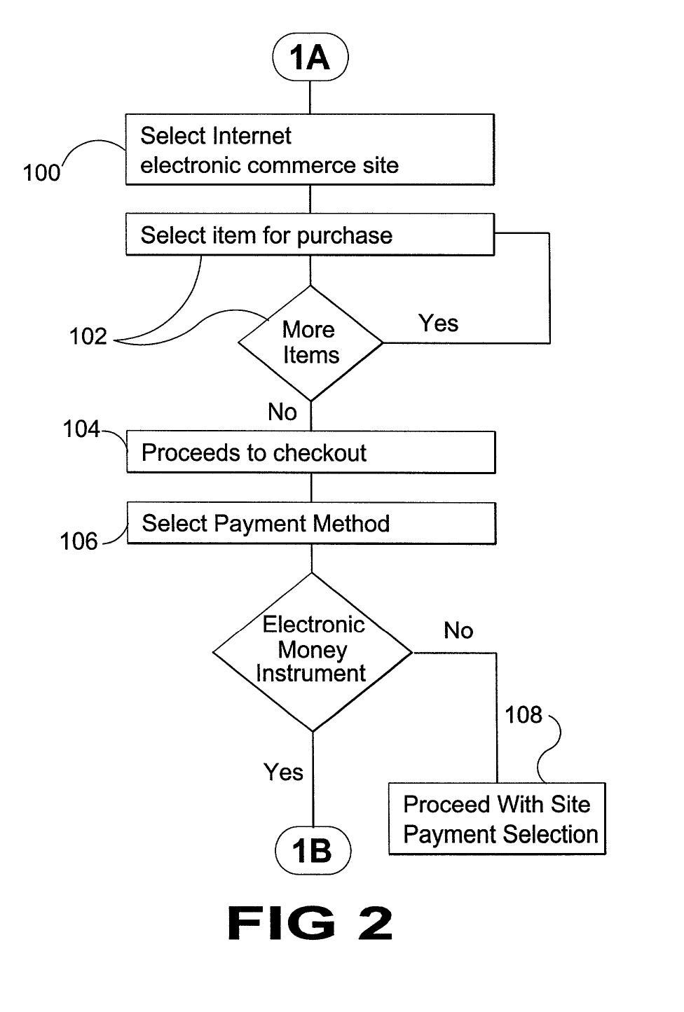

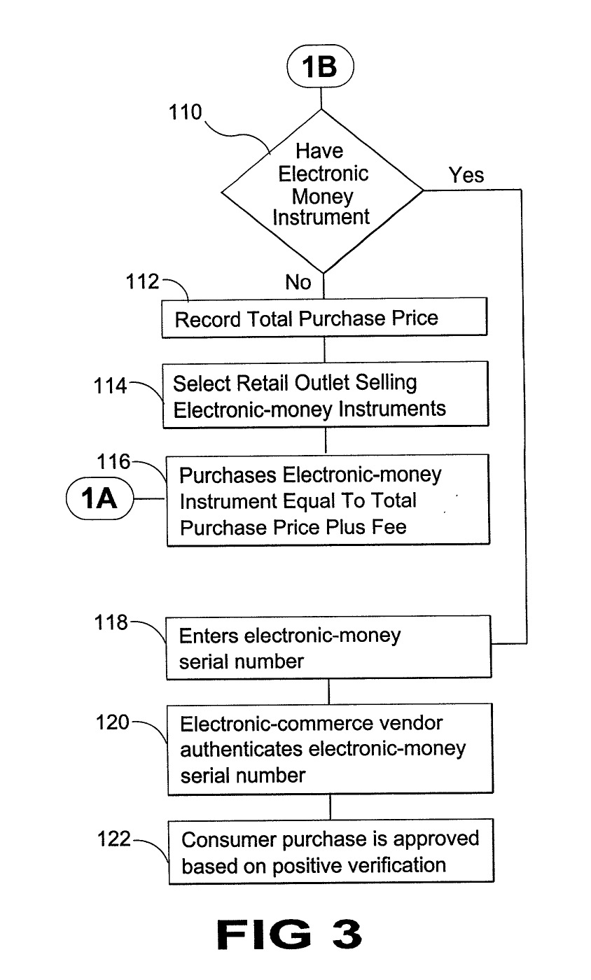

The electronic money instrument enables the highest level of security and privacy for the now common practice of completing financial transactions while at an online transaction site through which a third party sells goods and services, accepts contributions, receives bill and loan payments, and the like. As shown in the flow chart depicted in FIG. 2 and FIG. 3, and beginning at “1A”, the online shopper selects an Internet electronic commerce site 100 and chooses one or more items 102 before proceeding to “checkout” 104. At the “checkout” 104 the total amount needed to consummate the transaction is indicated, including all tax, shipping, etc. The online shopper then selects a payment method 106.

If the method chosen is a conventional method, the online shopper so indicates and proceeds to close the transaction 108.

If the online shopper decides to use the electronic money instrument (“1B”), and has not previously obtained the same 110, the online shopper records the total amount needed 112 and selects a retail outlet issuer 114 from which to purchase an electronic money instrument 116 in the amount so recorded.

Having acquired the electronic money instrument, the online shopper returns to the Internet electronic commerce site 100 and again selects the desired item or items 102, proceeds to checkout 104 and selects the electronic money instrument 106 as the payment method. Having the electronic money instrument 110, the online shopper then enters the unique serial number from the instrument 118 in the appropriate place on the Internet electronic commerce site.

Prior to consummating the transaction, the electronic commerce vendor authenticates the validity of the electronic money instrument serial number for a transaction in this amount, by electronic communication with the electronic money instrument issuer 120. If valid, the online shopper's transaction is approved 122 and so indicated on the electronic commerce site.

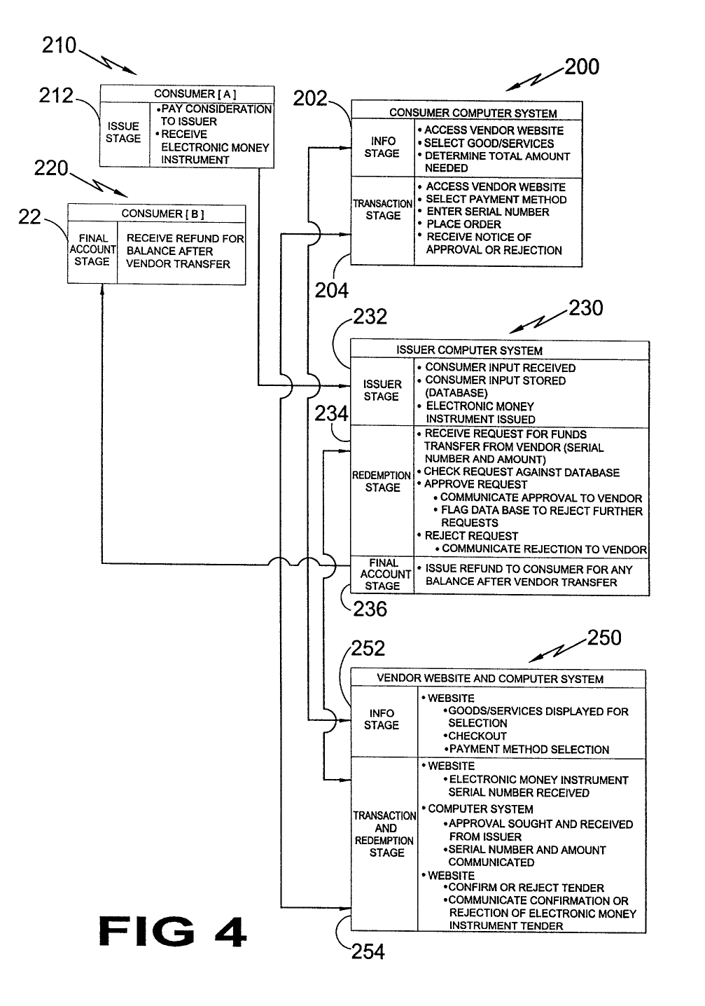

FIG. 4 is a block diagram depicting the computer system requirements for the typical online shopping transaction using the electronic money instrument. The consumer system 200 has the necessary hardware components and software at the information stage 202 to access the vendor's electronic commerce website, input the consumer's selections, and receive the vendor's information concerning the total amount needed to consummate the transaction. The consumer system's information stage 202 is in electronic communication with the vendor system 250 information stage 252, where corresponding information inputs and outputs enable the mutual transfer of information between the consumer and the vendor at this stage of the online endeavor.

FIG. 4 depicts the “Consumer [A]” box 210 to represent the activities of the consumer during the issue stage 212. The consumer can perform these steps physically and/or by electronic communication with the issuer computer system 230 that has the necessary hardware and software to perform the issuer's issue stage 232 requirements, such as needed to accomplish the issue of the electronic money instrument.

As indicated in FIG. 4, the consumer with the issued electronic money instrument, in the proper amount determined during the information stage 202,252, uses his or her computer system 200 to enter the transaction stage 204, i.e. the reestablishment of electronic communication with the vendor's computer system 250 website. The vendor's system 250 has the hardware and software necessary in a transaction stage 254 to accept the inputs from the consumer transaction stage hardware and software 204 and establish electronic communication with the issuer system's redemption stage hardware and software 234 for the indicated functions necessary to validate the consumer's intended use of the electronic money instrument, and to communicate the approval or rejection to the consumer's transaction stage hardware and software 204.

Also shown in FIG. 4 is the “Consumer [B]” box 220 that represents either the manual and/or electronic receipt of any refund due from the issuer after the transaction, the issuer's system 250 having final account stage hardware and software 236 for refunding the balance to the consumer.

The electronic money instrument systems utilize existing hardware that can be chosen in various combinations to enable the wide variety of visual and audible communication features used in computerized communication practices. With respect to the above description then, it is to be realized that the optimum system selections for the computer systems 200,230,250 will include numerous variations that will occur to those skilled in the art upon review of the present disclosure, and all equivalent relationships to those illustrated in the drawings and described in the specification are intended to be encompassed by the present invention.

What is claimed as new and desired to be protected by Letters Patent is set forth in the appended claims:

1. A method of providing tender from an issuer for a user transaction with a third party, comprising the steps of:
receiving a request from the user for the tender in a specified amount;
issuing to the user an item having a unique serial number to the user;
retrievably storing item information associating the tender amount with the serial number;
receiving a request for funds from the third party, the request including the serial number and the amount requested;
accessing the stored item information to determine if the tender amount associated with the serial number is at least as large as the requested amount;
approving the request if the tender amount associated with the serial number is at least as large as the requested amount;
refusing the request if the tender amount associated with the serial number is less than the requested amount; and
upon approval, retrievably storing additional item information associating the serial number with an indication that no further third party requests for finds can be approved.

2. The method of claim 1, wherein the step of retrievably storing item information includes storage in a remote hosting site serving more than one issuer.

3. The method of claim 1, wherein, prior to requesting the tender from the issuer, the user determines the amount of tender required to consummate the transaction with the third party.

4. The method of claim 3, wherein this determination is made using the information available on the third party's online site.

5. The method of claim 1, wherein the third party's request to the issuer is made by electronic communication

6. The method of claim 1, wherein the third party's request to the issuer is made online

7. The method of claim 1, which further comprises the step, by the issuer, of reimbursing the user for the difference between the tender amount and the amount of the approved third party request for funds.

8. The method of claim 7, wherein the reimbursement is made upon presentation of the item to the issuer.

9. The method of claim 8, wherein the presentation of the serial number to the issuer is made online.

10. The method of claim 1, wherein the step of receiving a request for a tender from a user further comprises:
receiving the request at a site that is remote from the issuer; and
forwarding the request from the remote site for receipt by the issuer.

11. The method of claim 10, wherein the site is a retail outlet selling the tender item.

12. The method of claim 10, wherein the step of issuing to the user an item having a unique serial number further comprises issuing the item for receipt by the user at the remote site.

13. The method of claim 1, wherein the item is a printed instrument.

14. The method of claim 1, wherein the item is an email to a location specified by the user.

15. The method of claim 1, wherein the item is an online message to a location specified by the user.

16. The method of claim 1, which further comprises the step of receiving a consideration from the user for issuing the item.

17. The method of claim 1, which further comprises the step of receiving a consideration from the third party for presenting the item for payment.

18. The method of claim 1, wherein the issued item also includes issuer contact information.

19. The method of claim 1, wherein the third party is the vendor.

20. The method of claim 1, wherein the third party is selling goods in the transaction.

21. The method of claim 1, wherein the third party is selling services in the transaction.

22. The method of claim 1, wherein the third party is accepting contributions in the transaction.

23. The method of claim 1, wherein the third party is accepting payments for previously owed sums in the transaction.

24. The method of claim 1, which further comprises a method for the third party to allow the user to use the issued tender item as tender for an online transaction with the third party, the method comprising the steps, by the third party, of:
providing a user-accessible online transaction site;
receiving the user's inputted selection of subject matter to be included in the transaction;
determining the amount of tender required to consummate the transaction based on the user's inputted selection of subject matter, and communicating the amount to the user;
receiving the user's selection of the issued tender item as the type of tender to be used to consummate the transaction;
receiving the tender item identification information upon entry by the user;
choosing between acceptance or rejection of the tender item, and communicating the choice to the user.

25. The method of claim 24, wherein the subject matter includes goods.

26. The method of claim 24, wherein the subject matter includes services.

27. The method of claim 24, wherein the subject matter includes donations to the third party.

28. The method of claim 24, wherein the subject matter includes payment of sums previously owed to the third party.

29. A method of providing tender from an issuer for a user transaction with a third party, comprising the steps of:
receiving a request from the user for the tender in a specified amount;
issuing an item having a unique serial number to the user;
retrievably storing item information associating the tender amount with the serial number;
receiving a request for funds from the third party, the request including the serial number and the amount requested;
accessing the stored item information to determine if the tender amount associated with the serial number is equal to the requested amount;
approving the request if the tender amount associated with the serial number is equal to the requested amount;
refusing the request if the tender amount associated with the serial number is not equal to the requested amount; and
if the third party request for funds was approved, retrievably storing additional item information associating the serial number with an indication that no further third party requests for funds can be honored.

30. A method of providing online transactions between a vendor and a user, comprising the steps, by the user, of:
accessing the vendor's online site;
selecting at least one item for purchase;
proceeding to checkout;
selecting between payment by an electronic money instrument and other payment methods;
if other payment methods are chosen, making payment with non-electronic money instrument;
if the electronic money instrument payment method is chosen, determining if an electronic money instrument is available in the amount required for payment;
if not available, noting the amount required, selecting an issuing outlet, purchasing the electronic money instrument from the outlet in the amount required, returning to the online site, and entering the electronic money instrument serial number as the payment method;
if available, entering the electronic money instrument serial number as the payment method;
upon entry of the serial number, waiting for the vendor to authenticate the electronic money instrument, by contacting the issuer, providing the serial number, requesting funds transfer, and receiving issuer approval; and
receiving an online approval from the vendor if the issuer verification was successful; receiving an online rejection if the issuer verification was unsuccessful.

31. A system of providing tender from an issuer for a user transaction with a third party, comprising:
means for receiving a request from the user for the tender in a specified amount;
means for issuing to the user an item having a unique serial number to the user;
means for retrievably storing item information associating the tender amount with the serial number;
means for receiving a request for funds from the third party, the request including the serial number and the amount requested;
means for accessing the stored item information to determine if the tender amount associated with the serial number is at least as large as the requested amount;
means for approving the request if the tender amount associated with the serial number is at least as large as the requested amount;
means for refusing the request if the tender amount associated with the serial number is less than the requested amount; and
means for retrievably storing additional item information associating the serial number with an indication that no further third party requests for funds can be approved after the first approval.

32. The system of claim 31, wherein the means for retrievably storing item information includes means for storage in a remote hosting site serving more than one issuer.

33. The system of claim 31, which further comprises means for determining the amount of tender required to consummate the transaction with the third party, prior to requesting the tender from the issuer.

34. The system of claim 33, wherein said means comprises the third party's online site.

35. The system of claim 31, wherein the means for receiving the third party's request for funds comprises electronic communication equipment.

36. The system of claim 31, wherein the means for receiving the third party's request for funds comprises online communication equipment.

37. The system of claim 31, which further comprises means for the issuer to reimburse the user for the difference between the tender amount and the amount of the approved third party request for funds.

38. The system of claim 31, wherein the means for receiving a request for a tender from the user further comprises:
means for receiving the request at a site that is remote from the issuer; and
means for forwarding the request from the remote site for receipt by the issuer.

39. The system of claim 38, wherein the site is a retail outlet selling the tender item.

40. The system of claim 38, wherein the means for issuing to the user an item having a unique serial number to the user further comprises means for issuing the item for receipt by the user at the remote site.

41. The system of claim 31, wherein the item is a printed instrument.

42. The system of claim 31, wherein the item is an email to a location specified by the user.

43. The system of claim 31, wherein the item is an online message to a location specified by the user.

44. The system of claim 31, which further comprises a system for the third party to allow the user to use the issued tender item as tender for an online transaction with the third party, the system comprising:
means for providing a user-accessible online transaction site;
means for receiving the user's inputted selection of subject matter to be included in the transaction;
means for determining the amount of tender required to consummate the transaction based on the user's inputted selection of subject matter, and means for communicating the amount to the user;
means for receiving the user's selection of the issued tender item as the type of tender to be used to consummate the transaction;
means for receiving the tender item identification information upon entry by the user;
means for choosing between acceptance or rejection of the tender item, and means for communicating the choice to the user.

45. A system for providing tender from an issuer for a user transaction with a third party, comprising:
means for receiving a request from the user for the tender in a specified amount;
means for issuing an item having a unique serial number to the user;
means for retrievably storing item information associating the tender amount with the serial number;
means for receiving a request for funds from the third party, the request including the serial number and the amount requested;
means for accessing the stored item information to determine if the tender amount associated with the serial number is equal to the requested amount;
means for approving the request if the tender amount associated with the serial number is equal to the requested amount;
means for refusing the request if the tender amount associated with the serial number is not equal to the requested amount; and
means for retrievably storing additional item information associating the serial number with an indication that no further third party requests for funds can be honored after the first approval.

46. A system for providing online transactions between a vendor and a user, comprising:
means for accessing the vendor's online site;
means for selecting at least one item for purchase;
means for proceeding to checkout;
means for selecting between payment by an electronic money instrument and other payment methods;
means for if other payment methods are chosen, means for making payment with non-electronic money instrument, if other payment methods are chosen;
if the electronic money instrument payment method is chosen, means for determining if an electronic money instrument is available in the amount required for payment if the electronic money instrument payment method is chosen;
means for noting the amount required, selecting an issuing outlet, purchasing the electronic money instrument from the outlet in the amount required, returning to the online site, and entering the electronic money instrument serial number as the payment method, if the electronic money instrument is not available;
means for entering the electronic money instrument serial number as the payment method, if the electronic money instrument is available;
means for the vendor to authenticate the electronic money instrument, by contacting the issuer, providing the serial number, requesting funds transfer, and receiving issuer approval; and
means for receiving an online approval from the vendor if the issuer verification was successful, or an online rejection if the issuer verification was unsuccessful.

47. A system for providing tender from an issuer for a user transaction with a third party, comprising:
a storage device;
a processor programmed to:
receive a request from the user for the tender in a specified amount;
issue to the user a tender item having a unique serial number to the user;
retrievably store item information associating the tender amount with the serial number;
receive a request for funds from the third party, the request including the serial number and the amount requested;
access the stored item information to determine if the tender amount associated with the serial number is at least as large as the requested amount;
communicate approval of the request to the third party if the tender amount associated with the serial number is at least as large as the requested amount;
communicate refusal of the request to the third party if the tender amount associated with the serial number is less than the requested amount; and
upon approval, retrievably store additional item information associating the serial number with an indication that no further third party requests for funds can be approved.

48. The system of claim 47, further comprising a printer, such that the tender item is issuable by printing.

49. The system of claim 47, further comprising a communication device, such that the processor issues the tender item by electronic communication with a site accessible by the user.

50. The system of claim 47, wherein the processor is further programmed to record a balance owed to the user if the amount requested by the vendor is less than the tender amount associated with the serial number.

51. The system of claim 47, wherein the storage device is a remote hosting site.

52. The system of claim 47, wherein the third party's request to the issuer is made online.

53. The system of claim 47, which further comprises at least one additional processor programmed to:
receive the user's inputted selection of subject matter to be included in the transaction from an online transaction site;
determine the amount of tender required to consummate the transaction based on the user's inputted selection of subject matter, and communicate the amount to the user through the online transaction site;
receive from the online transaction site the user's selection of the issued tender item as the type of tender to be used to consummate the transaction;
receive from the online transaction site the tender item identification information upon entry by the user; and
choose between acceptance or rejection of the tender item, and communicate the choice to the user.

54. A system for providing tender from an issuer for a user transaction with a third party, comprising:
a storage device;
a processor programmed to:
receive a request from the user for the tender in a specified amount;
issue to the user a tender item having a unique serial number to the user;
retrievably store item information associating the tender amount with the serial number;
receive a request for funds from the third party, the request including the serial number and the amount requested;
access the stored item information to determine if the tender amount associated with the serial number is equal to the requested amount;
communicate approval of the request to the third party if the tender amount associated with the serial number is equal to the requested amount;
communicate refusal of the request to the third party if the tender amount associated with the serial number is not equal to the requested amount; and
upon approval, retrievably store additional item information associating the serial number with an indication that no further third party requests for funds can be approved.

55. Computer readable media containing program instructions for execution on at least one computer system, which when executed by at least one computer, cause the at least one computer system to perform method steps for providing tender from an issuer for a user transaction with a third party, the method comprising the steps of:
receiving a request from the user for the tender in a specified amount;
issuing to the user an item having a unique serial number to the user;
retrievably storing item information associating the tender amount with the serial number;
receiving a request for funds from the third party, the request including the serial number and the amount requested;
accessing the stored item information to determine if the tender amount associated with the serial number is at least as large as the requested amount;
approving the request if the tender amount associated with the serial number is at least as large as the requested amount;
refusing the request if the tender amount associated with the serial number is less than the requested amount; and
upon approval, retrievably storing additional item information associating the serial number with an indication that no further third party requests for funds can be approved.

56. The computer readable media of claim 55, wherein the step of retrievably storing item information includes storage in a remote hosting site serving more than one issuer.

57. The computer readable media of claim 55, wherein the method further comprises the step of recording a balance owed to the user if the amount requested by the vendor is less than the tender amount associated with the serial number.

58. The computer readable media of claim 55, wherein the method further comprises the step, by the issuer, of reimbursing the user for the difference between the tender amount and the amount of the approved third party request for funds.

59. The computer readable media of claim 55, wherein the third party's request to the issuer is made online

60. The computer readable media of claim 55, which further contains program instructions for execution on at least one additional computer system, which when executed by the at least one additional computer system, causes the at least one computer system to perform method steps for the third party to allow the user to use the issued tender item as tender for an online transaction with the third party, the method comprising the steps of:
providing a user-accessible online transaction site;
receiving the user's inputted selection of subject matter to be included in the transaction;
determining the amount of tender required to consummate the transaction based on the user's inputted selection of subject matter, and communicating the amount to the user;
receiving the user's selection of the issued tender item as the type of tender to be used to consummate the transaction;
receiving the tender item identification information upon entry by the user; and
choosing between acceptance or rejection of the tender item, and communicating the choice to the user.

61. Computer readable media containing program instructions for execution on at least one computer system, which when executed by at least one computer, cause the at least one computer system to perform method steps for providing tender from an issuer for a user transaction with a third party, the method comprising the steps of:
receiving a request from the user for the tender in a specified amount;
issuing to the user an item having a unique serial number to the user;
retrievably storing item information associating the tender amount with the serial number;
receiving a request for funds from the third party, the request including the serial number and the amount requested;
accessing the stored item information to determine if the tender amount associated with the serial number is equal to the requested amount;
approving the request if the tender amount associated with the serial number is equal to the requested amount;
refusing the request if the tender amount associated with the serial number is not equal to the requested amount; and
upon approval, retrievably storing additional item information associating the serial number with an indication that no further third party requests for funds can be approved.
